(19) United States
(12) Patent Application Publication
(10) Pub. No.: US 2013/0069824 A1
(43) Pub. Date: Mar. 21, 2013

(54) Global Navigation System Signal Tracking and Decoding

(71) Applicants: Premal Madhani, Los Gatos, CA (US); Matthew Riben, Cupertino, CA (US); Robert Abad, Sunnyvale, CA (US)

(72) Inventors: Premal Madhani, Los Gatos, CA (US); Matthew Riben, Cupertino, CA (US); Robert Abad, Sunnyvale, CA (US)

(73) Assignee: BROADCOM CORPORATION, Irvine, CA (US)

(21) Appl. No.: 13/238,701

(22) Filed: Sep. 21, 2011

(51) Int. Cl. G01S 19/30; G01S 19/36

(52) U.S. Cl. 342/357.69; 342/357.76

(57) ABSTRACT

Disclosed are various embodiments of global navigation system tracking and decoding. In one embodiment a method includes obtaining a navigation signal including a sequence of navigation strings. Each navigation string includes symbol encoded navigation data symbols and a time mark sequence (TMS). A location of a TMS within the navigation signal is determined and the TMS and the symbol encoding is removed from a subsequent navigation string based upon the determined location of the TMS to provide a stripped navigation signal. In another embodiment, a global navigation receiver includes a RF front end that obtains a navigation signal including a sequence of navigation strings. The global navigation receiver determines a location of a TMS within the navigation signal and removes the TMS and symbol encoding from a subsequent navigation string based upon the determined location of the TMS to provide a stripped navigation signal.

### BACKGROUND

A global positioning system (GPS) is a space-based global navigation satellite system (GNSS) that can provide location and time information around the world. The United States maintains the NAVSTAR global navigation satellite system and Russia maintains an alternative and complementary global navigation satellite system (GLONASS). Geo-spatial positioning information transmitted by the GNSS is used to determine global position around the world in a wide range of applications.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a graphical representation of a global navigation satellite system (GNSS) in accordance with various embodiments of the present disclosure.

FIG. 2 is a graphical representation of an example of a GLONASS navigation data string transmitted by a GNSS of FIG. 1 in accordance with various embodiments of the present disclosure.

FIG. 3 is a flowchart illustrating an example of processing a navigation signal including a navigation data string of FIG. 2 in accordance with various embodiments of the present disclosure.

FIG. 4 is a graphical representation of an example of a receiver of FIG. 1 in accordance with various embodiments of the present disclosure.

### DETAILED DESCRIPTION

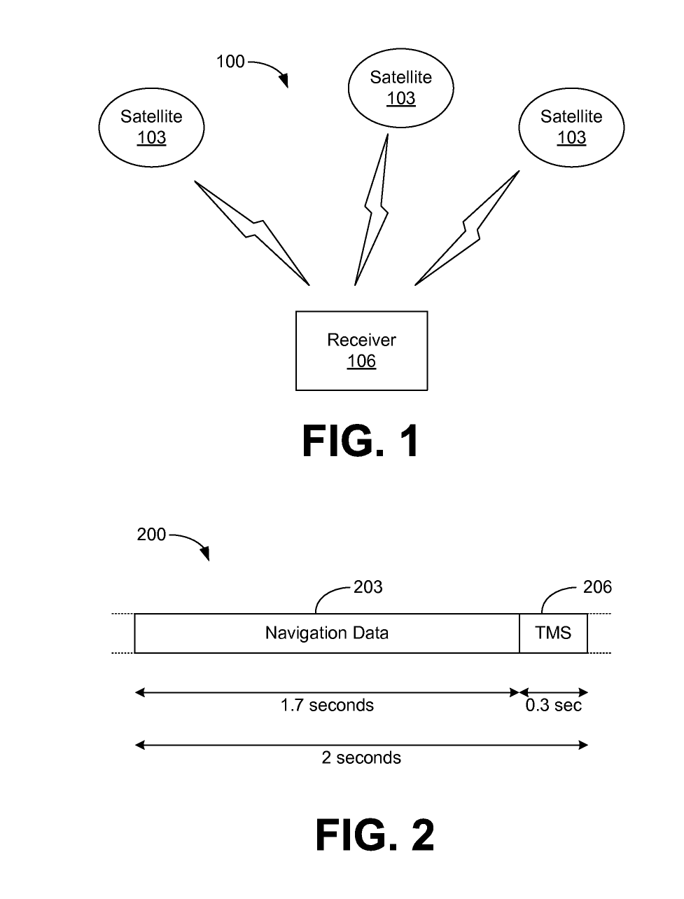

With reference to FIG. 1, shown is a graphical representation of an example of a global positioning system (GPS) 100. A plurality of global navigation satellites 103 transmit information regarding their orbit and clock states that is received by a GPS receiver 106. The orbit and clock information obtained from the satellites 103 by the receiver 106 is used to determine the global location of the receiver 106. In the case of a GLONASS satellite signal, information regarding the satellite orbit and clock state is transmitted in a navigation signal at, e.g., 50 bps in strings with an information bit interval of 20 ms. GLONASS sends the navigation data in the navigation signal including a series of two second long navigation data strings. FIG. 2 provides a graphical representation of an example of a GLONASS navigation data string 200. The first 1.7 seconds of the string 200 includes navigation data 203 such as, e.g., satellite orbital and clock data. The bits of the navigation data 203 are encoded symbols using symbol encoding such as, e.g., Manchester encoding. The Manchester encoding may be in accordance with IEEE 802.3 or in accordance with the G.E. Thomas convention. The duration of the encoded symbol restricts the integration time during decoding of the symbol. For example, for a 10 ms symbol duration, the integration time is limited to 10 ms. A time mark sequence (TMS) 206 is appended to the end of the navigation data 203 for the last 0.3 seconds of the string 200. The TMS 206 is a pseudo-random sequence that is known.

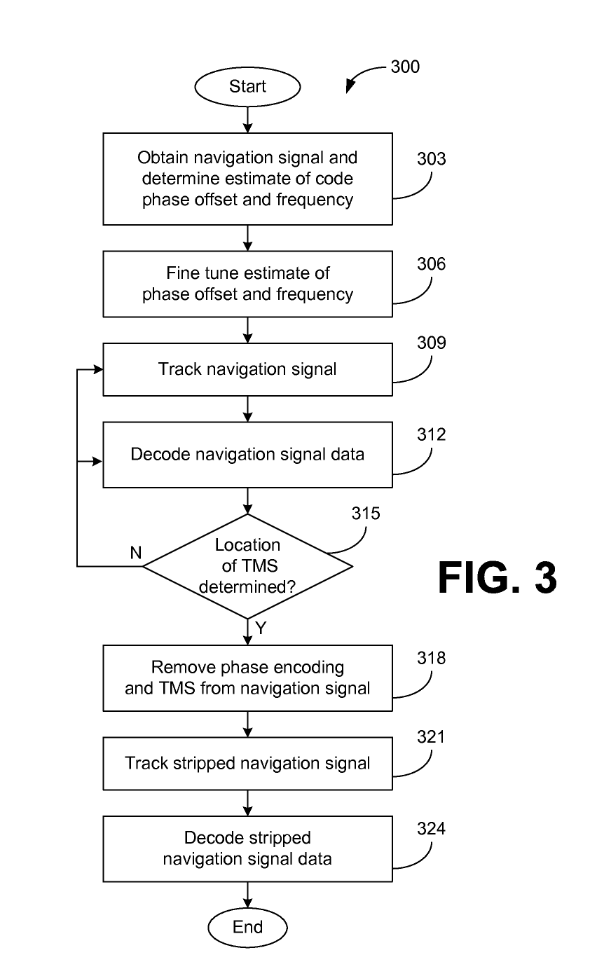

Referring next to FIG. 3, shown is a flow diagram 300 illustrating the processing of the navigation signal acquired from the navigation satellites 103. Beginning with block 303, an acquisition stage obtains the navigation signal and determines a rough estimate of the code phase offset and frequency of the navigation signal. After the navigation signal is acquired, the estimates of the phase offset and frequency are fine tuned in block 306. This may be accomplished using bit estimation and finer frequency estimation. The navigation signal is then tracked in block 309 based at least in part upon the fine-tuned estimates. In this stage, the frequency of the signal and the code phase is tracked to a very high accuracy. In addition to tracking the navigation signal, the navigation signal data is decoded in block 312 by integrating over the duration of the encoded symbols such as, e.g., 10 ms Manchester symbols.

The location of a TMS within the navigation signal is determined in block 315. The known pseudo-random TMS may be identified from the decoded navigation signal data. In other implementations, accurate aiding may be used to determine the TMS location. Once the location of the TMS is determined within the sequence of decoded navigation signal data, the symbol encoding sequence is also known. If the location of the TMS has not been determined, then the tracking and decoding of the navigation signal continues in blocks 309 and 312. When the location of the TMS is determined in block 315, the symbol encoding and TMS (or wipeoff data) are removed (or stripped) from the navigation signal based (at least in part) upon the location of the TMS in block 318 and the tracking of the stripped navigation signal that is devoid of the symbol encoding and TMS is started in block 321. The wipeoff data (e.g., Manchester symbols and TMS) may be generated by, e.g., an application specific integrated circuit (asic) in the receiver 106. In other implementations, the wipeoff data may be generated by a network server that would then transmit the encoding data to a host platform which would provide the wipeoff data to an asic of the receiver 106.

In addition, the stripped navigation signal data is decoded in block 324 by integrating over the duration of the exposed navigation data. The integration time may be adjusted based at least in part upon the duration of the underlying navigation data. Because the symbol encoding (e.g., Manchester encoding) has been removed from the navigation signal to get to the underlying navigation data bits, the integration time can be increased to the duration of the underlying data bits. For example, by increasing the decoding integration time from 10 ms to 20 ms by stripping the symbol encoding, a 3 dB improvement in bit detection may be achieved. In addition, the extended bit time may also improve tracking sensitivity by 6 dB. If the navigation signal data bits are known, then integrations beyond 20 ms can be accommodated by stripping the underlying navigation data bits before integration. During the 300 ms TMS, all the navigation data bits are known.

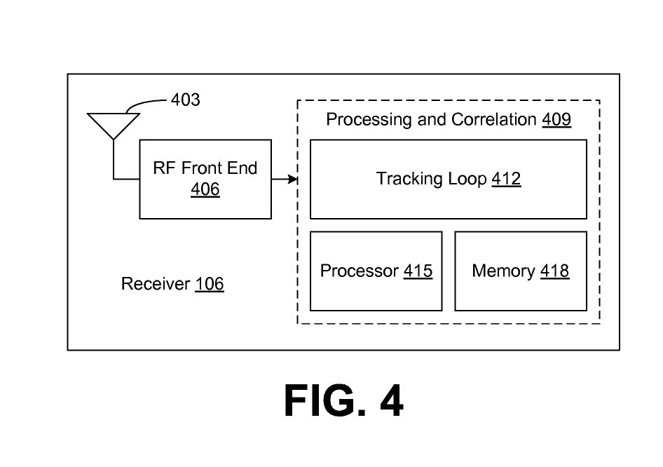

Referring to FIG. 4, shown is a graphical representation of an example of the receiver 106 of FIG. 1. The receiver 106 includes an antenna 403 and an RF front end 406 for converting the navigation signal received from the global navigation satellites 103 (FIG. 1). The RF front end 406 may provide the rough estimate and/or fine tuning of the code phase offset and the frequency of the acquired signal. The RF front end 406 may also provide analog-to-digital conversion of the navigation signal. The receiver 106 also includes signal processing and correlation 409 of the navigation signal. Feedback signals for the estimation and tuning may be provided by the processing and correlation 409.

The processing and correlation 409 of the receiver 106 includes a tracking loop 412, processor 415 and memory 418. The tracking loop 412 may be embodied in dedicated hardware and/or software implemented by processor 415 and/or other general purpose hardware. The tracking loop 412 is configured to track the navigation signal acquired from the navigation satellites 103. In the tracking loop 412, the frequency of the signal and the code phase is tracked to a very high accuracy. The tracking loop 412 may also provide fine tuning of the rough estimates of the phase offset and frequency of the navigation signal before the high accuracy tracking. In addition to tracking the navigation signal, the tracking loop 412 decodes the navigation signal data by integrating over the duration of the encoded symbols such as, e.g., 10 ms Manchester symbols.

The receiver 106 includes at least one processor circuit, for example, having a processor 415 and a memory 418, both of which are coupled to a local interface. The local interface may comprise, for example, a data bus with an accompanying address/control bus or other bus structure as can be appreciated. Stored in the memory 418 are both data and several software components that are executable by the processor 415. In particular, stored in the memory 418 and executable by the processor 415 is software code that, when executed by the processor, implement various functions associated with the global navigation receiver 106. Also stored in the memory 415 may be a data store and other navigation data. In addition, an operating system may be stored in the memory 418 and executable by the processor 415.

The software or code, when executed by the processor, can determine the location of a time mark sequence (TMS) 206 (FIG. 2) within the tracked navigation signal. The known pseudo-random TMS may be identified from the decoded navigation signal data. In some embodiments, the navigation signal data is decoded using code executed by the processor 415. In other embodiments, the location of the TMS 206 may be determined by making use of accurate aiding from an external source such as, e.g., a cellular network. For example, when a GNSS receiver is embedded in a mobile handset or self-generated aiding is utilized when the receiver is navigating with the navigation filter having a tight convergence on the state estimate. In the case of accurate aiding, there is no need to decode the navigation data in a GLONASS satellite signal to determine the TMS location.

When the location of the TMS is determined, executed code may initiate or trigger the tracking loop to remove (or strip) the symbol encoding and the TMS from the navigation signal based (at least in part) upon the location of the TMS and begin tracking of the stripped navigation signal based at least in part upon the location of the TMS. The tracking loop 412 may decode the stripped navigation signal data by integrating over the duration of the exposed navigation data. In other embodiments, the exposed navigation data is decoded using code executed by the processor 415. Other navigation processing such as, e.g., determining the global location using the decoded navigation information and rendering the location information for display through a user interface associated with the receiver 106 may also be implemented by code or software executed by the processor 415.

It is understood that there may be other software or code that are stored in the memory 418 and are executable by the processor 415 as can be appreciated. Where any component discussed herein is implemented in the form of software, any one of a number of programming languages may be employed such as, for example, C, C++, C#, Objective C, Java, Java Script, Perl, PHP, Visual Basic, Python, Ruby, Delphi, Flash, or other programming languages.

A number of software components are stored in the memory 418 and are executable by the processor 415. In this respect, the term “executable” means a program file that is in a form that can ultimately be run by the processor 415. Examples of executable programs may be, for example, a compiled program that can be translated into machine code in a format that can be loaded into a random access portion of the memory 418 and run by the processor 415, source code that may be expressed in proper format such as object code that is capable of being loaded into a random access portion of the memory 418 and executed by the processor 415, or source code that may be interpreted by another executable program to generate instructions in a random access portion of the memory 418 to be executed by the processor 415, etc. An executable program may be stored in any portion or component of the memory 418 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 418 is defined herein as including both volatile and nonvolatile memory and data storage components. Volatile components are those that do not retain data values upon loss of power. Nonvolatile components are those that retain data upon a loss of power. Thus, the memory 418 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 415 may represent multiple processors 415 and the memory 418 may represent multiple memories 418 that operate in parallel processing circuits, respectively. In such a case, the local interface may be an appropriate network that facilitates communication between any two of the multiple processors 415, between any processor 415 and any of the memories 418, or between any two of the memories 418, etc. The local interface may comprise additional systems designed to coordinate this communication, including, for example, performing load balancing.

Although various functionality described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flow chart of FIG. 3 shows functionality and operation of an implementation of portions of signal tracking and decoding executed by the global navigation receiver 106. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 415 or other processor system. The machine code may be converted from the source code, etc. If embodied in hardware, each block may represent a circuit or a number of interconnected circuits to implement the specified logical function(s).

Although the flow chart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any application or functionality described herein that comprises software or code can be embodied in any non-transitory computer-readable medium for use by or in connection with an instruction execution system such as, for example, a processor 415 or other processor system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a range of “about 0.1% to about 5%” should be interpreted to include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, having thus described the invention, at least the following is claimed:

1. A method, comprising:
obtaining a navigation signal including a sequence of navigation strings, each navigation string comprising symbol encoded navigation data symbols and a time mark sequence (TMS);
determining a location of a TMS within the navigation signal; and
removing the TMS and the symbol encoding from a subsequent navigation string based upon the determined location of the TMS to provide a stripped navigation signal.

2. The method of claim 1, wherein the symbol encoded navigation data are Manchester symbols.

3. The method of claim 1, further comprising:
tracking the navigation signal; and
decoding the navigation signal data symbols, where the location of the TMS is determined from the decoded navigation signal data.

4. The method of claim 3, wherein the symbol encoded navigation data symbols are decoded by integrating over the duration of each encoded navigation data symbol.

5. The method of claim 4, wherein the duration of the encoded navigation data symbols is 10 milliseconds.

6. The method of claim 1, further comprising tracking the stripped navigation signal.

7. The method of claim 6, further comprising decoding the stripped navigation signal data to determine the underlying navigation data.

8. The method of claim 7, wherein the stripped navigation data is decoded by integrating over the duration of each underlying navigation data bit.

9. The method of claim 8, wherein the duration of the underlying navigation data bit is 20 milliseconds.

10. A global navigation receiver, comprising:
a radio frequency (RF) front end configured to obtain a navigation signal including a sequence of navigation strings, each navigation string comprising symbol encoded navigation data symbols and a time mark sequence (TMS);
a processor; and
memory storing code that, when executed by the processor:
determines a location of a TMS within the navigation signal; and
removes the TMS and the symbol encoding from a subsequent navigation string based upon the determined location of the TMS to provide a stripped navigation signal.

11. The global navigation receiver of claim 10, wherein the symbol encoded navigation data are Manchester symbols.

12. The global navigation receiver of claim 10, further comprising a tracking loop configured to track the navigation signal.

13. The global navigation receiver of claim 12, wherein the tracking loop is further configured to decode the navigation signal data symbols, where the location of the TMS is determined from the decoded navigation signal data.

14. The global navigation receiver of claim 13, wherein the symbol encoded navigation data symbols are decoded by integrating over the duration of each encoded navigation data symbol.

15. The global navigation receiver of claim 12, wherein the memory further stores code that, when implemented by the processor, decodes the navigation signal data symbols, where the location of the TMS is determined from the decoded navigation signal data.

16. The global navigation receiver of claim 12, wherein the tracking loop is further configured to track the stripped navigation signal.

17. The global navigation receiver of claim 16, further comprising decoding the stripped navigation signal data to determine the underlying navigation data.

18. The global navigation receiver of claim 17, wherein the stripped navigation data is decoded by integrating over the duration of each underlying navigation data bit.

19. The global navigation receiver of claim 18, wherein the duration of the underlying navigation data bit is 20 milliseconds.

20. The global navigation receiver of claim 16, wherein the memory further stores code that, when implemented by the processor, decodes the stripped navigation signal data to determine the underlying navigation data.
